(19) United States
(12) Patent Application Publication
(10) Pub. No.: US 2026/0132522 A1
(43) Pub. Date: May 14, 2026

(54) METHOD FOR JOINING A STACK OF ELEMENTS TOGETHER

(71) Applicant: JOHN COCKERILL HYDROGEN BELGIUM, Seraing (BE)

(72) Inventors: David D'AMBROSIO, Seraing (BE); Luc VANHÉE, Seraing (BE)

(73) Assignee: JOHN COCKERILL HYDROGEN BELGIUM, Seraing (BE)

(21) Appl. No.: 19/119,124

(22) PCT Filed: Oct. 10, 2023
(86) PCT No.: PCT/EP2023/078086

§ 371 Date: Apr. 8, 2025

(30) Foreign Application Priority Data
Oct. 10, 2022 (EP) 22200483.0

(51) Int. Cl. C25B 9/75; C25B 9/67

(52) U.S. Cl. CPC C25B 9/75; C25B 9/67

(57) ABSTRACT

A method for joining a stack of elements together, the method includes the steps of: individually joining subassemblies of the elements together; joining the subassemblies together by arranging a joint between each subassembly to form the stack of elements; and applying consecutive phases of heating and cooling to the stack of elements while applying at least one clamping action to the stack of elements between two different phases of heating and cooling.

The invention relates to a method for assembling a stack of elements together.

The invention preferably, but nonlimitingly, relates to a method for assembling an electrolyzer stack.

### BACKGROUND OF THE INVENTION

The general architecture of an electrolyzer stack is usually made up of a block of electrolytic cells, which are stacked in series from an electrical viewpoint and in parallel from a fluidic viewpoint, and seals.

The aim of each electrolytic cell is to promote the electrolysis of an electrolyte solution (alkaline water, pure water, non-purified water, salt, aqueous chloride solution, aqueous bromide solution, aqueous hydrochloric acid solution, etc.). For example, the function of an electrolyzer stack is to promote the reaction for producing dihydrogen (H₂) and dioxygen (O₂) gas resulting from the dissociation of water after injecting a direct electrical current into an alkaline solution, generally potassium hydroxide (KOH) or sodium hydroxide (NaOH).

Each electrolytic cell, which is considered to be a mainly metal, conductive part (but some portions of which can be non-metal), is generally made up of two bipolar plates, flanking two inserts (more commonly known as flow field material), in turn flanking two electrodes, generally in the form of metal plates or grilles or meshes. In the case of an alkaline electrolyzer stack, said electrodes are generally made from nickel. The two electrodes (a cathode and an anode) are separated by a membrane (also referred to as a diaphragm or porous separator in the case of an alkaline electrolyzer), which ensures the electrical insulation between the two electrodes, the separation of the gases, and the ionic conduction within the electrolytic cell.

The insert has two functions: i) to provide a low-resistivity metal path between each bipolar plate and the associated electrode and ii) to allow appropriate circulation of the electrolyte solution for cooling the electrolyzer stack and transporting the gases generated.

The name bipolar plate comes from the fact that because the electrolytic cells are all placed side by side, a bipolar plate N will have a potential that is:
higher relative to the downstream bipolar plate N+1, so that the bipolar plate N will act as the anode in an electrolytic cell defined by the bipolar plates N and N+1;
lower relative to the upstream bipolar plate N−1, so that the bipolar plate N will act as the cathode in an electrolytic cell defined by the bipolar plates N−1 and N.

The other metal parts, in addition to the bipolar plates, include the distribution plates (which make it possible to supply and distribute electricity to the electrolytic cells) and the base plates (which make it possible to define the assembly of electrolytic cells and ensure the tightening of said cells together and the sealing thereof). In fact, the electrolyzer stack ends in two base plates situated just before the first electrolytic cell and just after the last electrolytic cell of the stack, that is, one base plate is located upstream of the block of electrolytic cells and the other base plate is placed downstream thereof with a view to physically defining the two ends of said block of electrolytic cells.

The electrolyte solution present in each electrolytic cell, together with the gases produced by electrolysis (such as hydrogen gas, oxygen gas, chlorine gas, and halogen gas, etc.), must not leak from the edge of the diaphragm out of the electrolytic cell in question, but must circulate solely through the dedicated ducts (each duct being dedicated either to the electrolyte only, or to the electrolyte mixed with one of the gases, taking into account that the two gases can also not be mixed together). The electrolyzer stack cannot therefore operate continuously if a leak is observed, said leak coming from the electrolyte solution, from the gases generated by electrolysis, or from any other substance.

This means that in many cases, various problems with a negative impact on the environment and also on the safety of the operators arise with a varying degree of severity, which can be significant and linked to irreversible consequences.

Conventionally, in an electrolytic cell as described above, the assembly applied in order to avoid any leaks coming from the electrolyte solution, from the gas or gases generated by electrolysis and/or from any other substance, from the edge of the diaphragm of the electrolytic cell out of said electrolytic cell, is based on the use of a plurality of thin seals in the form of a sheet or a plurality of O-rings, often elastomeric, so that said seals or O-rings are positioned between the anode and the cathode or the membrane of an electrolytic cell, or directly between two adjacent bipolar plates. The diaphragm is thus sandwiched between these different sealing elements.

Although these seals have satisfactory sealing properties, they can be impaired due to the phenomenon of creep, which is also more or less intense depending on the quality and composition of the material used. As a result, if such seals are used, the sealing of the electrolyzer stack ultimately generally deteriorates (and even more specifically within each electrolytic cell). In addition, this creep phenomenon occurs all the more quickly if one of the influencing factors, such as temperature, has undesirable effects on the seal in question.

### OBJECT OF THE INVENTION

One aim of the invention is to propose a solution that makes it possible to ensure long-term satisfactory sealing of an assembly of a stack of elements together.

### SUMMARY OF THE INVENTION

To this end, the invention relates to a method for assembling a stack of elements, comprising the steps of:
individually assembling subassemblies of said elements,
assembling the subassemblies together, arranging a seal between each subassembly to form the stack of elements,
applying successive heating and cooling phases to the stack of elements, applying at least one operation of tightening the stack of elements between two different heating and cooling phases.

The inventors have surprisingly observed that applying successive tightening operations at different temperatures provided a way of controlling the creep of the seals by causing it to occur prematurely but deliberately in order to suppress it as much as possible before the stack of elements is actually used.

In particular, the invention makes it possible to achieve a high level of mechanical stability in the seal material by alternating thermal stresses (heating and cooling of the elements) and mechanical stresses (compressing the elements).

The invention thus makes it possible to ensure satisfactory final sealing of the stack of elements, even in the long term, for example over a timescale of 10 to 20 years.

The invention is particularly suitable for assembling stacks of elements having large dimensions.

Optionally, the stack of elements is an electrolyzer stack, the subassemblies thus being pairs of electrolytic half-cells.

The method thus makes it possible to ensure satisfactory final sealing of the electrolyzer stack, even in the long term, for example over a timescale of 10 to 20 years.

The method is particularly suitable for use in an electrolyzer stack having large dimensions, in which the bipolar plates can have an area of up to several square meters of electrodes per electrolytic cell and/or in an electrolyzer stack intended to operate at high pressure (for example at a pressure of between 1 and 3 megapascals, for example a pressure of between 3 and 5 megapascals, for example a pressure greater than 5 megapascals).

Optionally, the stack of elements is an electrolyzer stack, the subassemblies thus being pairs of electrolytic half-cells.

Optionally, the method comprises a step of pre-tightening the stack of elements before the step of applying successive heating and cooling phases to the stack of elements, applying at least one operation of tightening the stack of elements between two different heating and cooling phases.

Optionally, the pre-tightening step is carried out incrementally.

Optionally, the elements are heated by injecting steam into the elements.

Optionally, the steam is water vapor.

Optionally, the elements are heated by injecting hot water into the elements.

Optionally, the cooling of the elements is forced.

Optionally, the cooling of the elements is natural.

Optionally, at least two iterations of the following phases are carried out:
heating the inside of the stack of elements,
tightening the various elements with respect to one another,
cooling the various elements with respect to one another,
tightening the various elements with respect to one another.

Optionally, the iterations are stopped when at least one predefined compression ratio of at least one seal in the stack of elements is reached.

Optionally, at least one subassembly is assembled by fastening two bipolar plates together so as to clamp at least one seal between the two plates.

Optionally, a single seal is clamped between the two bipolar plates.

Optionally, the stack of elements is arranged vertically and/or horizontally.

Other features and advantages of the invention will become apparent on reading the following description of a non-limiting particular embodiment of the invention.

### BRIEF DESCRIPTION OF THE DRAWINGS

Reference will be made to the appended drawings, in which:

FIG. 1 is an exploded schematic view of an electrolytic cell of an electrolyzer stack assembled according to one particular embodiment of the invention,

FIG. 2 is a perspective view of a bipolar plate of the electrolytic cell shown in FIG. 1,

FIG. 3a is a cross-sectional view of part of the bipolar plate illustrated in FIG. 2,

FIG. 3b is a cross-sectional view of part of the bipolar plate illustrated in FIG. 2, also showing a membrane of said electrolytic cell,

FIG. 3c is a cross-sectional view of part of the electrolytic cell shown in FIG. 1,

FIG. 4 is a view of an electrolyzer stack comprising electrolytic cells as illustrated in FIG. 1,

FIG. 5 is a graph illustrating the mean reduction in thickness of a seal of one of the cells of the electrolyzer stack illustrated in FIG. 4 on assembly of said stack.

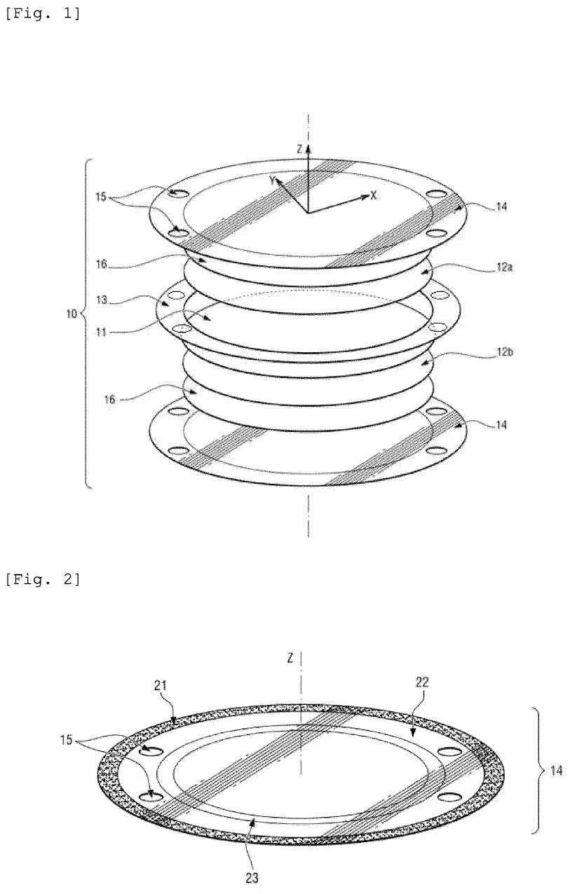

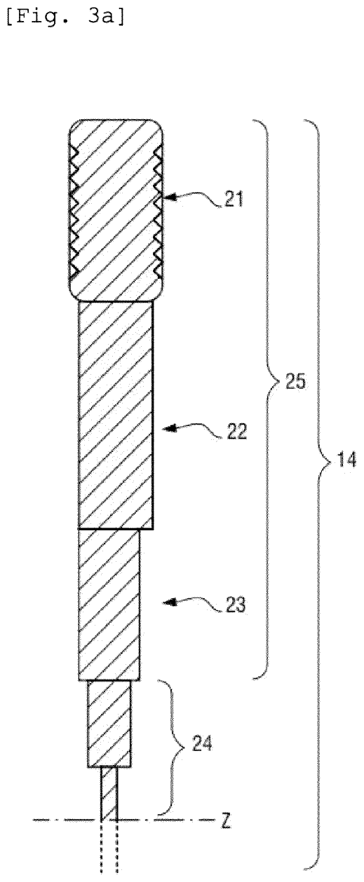

### DETAILS OF THE INVENTION

With reference to the various figures, a stack of elements extends longitudinally in a general direction A.

In the present case, the stack of elements is an electrolyzer stack, the various elements being formed for the most part by electrolytic cells which will be described below.

The electrolyzer stack 1 comprises a block 2 of electrolytic cells that comprises at least two electrolytic cells that are mounted side by side in the general direction A. Within the block 2, the electrolytic cells are mounted in parallel from a fluidic viewpoint and in series from an electrical viewpoint.

At the two ends (in the general direction A) of the block 2, the electrolyzer stack 1 comprises two base plates 3 and 4.

These base plates 3 and 4 form supports between which the electrolytic cells are compressed so that the electrolyzer stack 1 s sealed and so that high quality electrical contact is created inside the electrolytic cells.

In addition, the base plates 3 and 4 make it possible to withstand the forces generated by the pressure inside the block 2, as well as the forces outside the block 2 necessary for ensuring the compression of the block 2.

The base plates 3 and 4 can act as electrical conductors and current distributors.

Preferably, the electrolyzer stack 1 comprises a first distribution plate 5 associated with the first base plate 3, and a second distribution plate 6 associated with the second base plate 4. In this case, the distribution plates 5 and 6 act as electrical conductors and current distributors.

The first distribution plate 5 (associated with the positive terminal) is arranged upstream of the block 2, and the second distribution plate 6 (associated with the negative terminal) is arranged downstream of said block 2. The notions “upstream” and “downstream” are defined in the direction of circulation of the current through the block 2.

A first of the two distribution plates 5 is connected to the positive terminal of the electrolyzer stack 1. One portion of the inner main face of the first base plate 3 (main face facing toward the block 2 and in particular the distribution plate 5) is therefore covered with a patch of electrically insulating material. Said portion is for example arranged in the center of said inner main face.

The second of the two distribution plates 6 is connected to the negative terminal of the electrolyzer stack 1. The second base plate 4 is at the same potential and also acts as a bridge for the supply of an electrolyte solution and the discharge of this same solution carrying the gases formed during electrolysis in the block 2.

Holes are thus made in said second base plate 4. Said holes often have different cross sections between the two main faces of the second base plate 4. For example, the outer main face (the one facing toward the outside of the block 2) comprises one hole or two holes (for example cylindrical) for supplying electrolyte solution, and two holes for discharging electrolytic reaction products in addition to the heated electrolyte solution. Three or four holes are made on the inner main face (on the opposite side from the outer main face) of said second base plate 4 for the same purpose, for example oblong holes in order to improve the distribution or collection of the fluids. For example, the holes of the outer main face are provided with flanges suitable for connecting electrolyte solution intake and return hoses.

In addition, here, the electrolyzer stack 1 is supplied with direct current.

For example, the first distribution plate 5 has a potential of approximately 700 volts, while the second distribution plate 6 has a potential of 0 volts. The supply and discharge of electrolyte solution take place through the second distribution plate 6 and the second base plate 4, the second distribution plate 6 having a potential of 0 volts, which prevents any current leakage (the potential of the second distribution plate 6 being the ground potential).

Inside the electrolyzer stack 1, the current passes through the electrolyte solution through a membrane 11, which will be described below. Within the block 2 there are seals (which will be described below); these seals are selected in a material that has much higher electrical resistance than the electrolyte solution.

The electrolyzer stack 1 comprises an end seal (not shown in the figures) arranged between the first distribution plate 5 and the first base plate 3. The first base plate 3 is grounded so that the potential difference at said end seal reaches the same value as the voltage applied between the positive and negative terminals of the electrolyzer stack 1, for example approximately 700 volts.

As a result, the first base plate 3 is electrically insulated from the block 2.

For example, the electrolyzer stack 1 comprises a layer (not shown in the figures) made from an electrically insulating material, which layer is arranged between the first base plate 3 and the first distribution plate 5.

The layer is for example an inserted disk or a deposit made on the first base plate 3 and/or the first distribution plate 5.

The electrolyzer stack 1 comprises means for fastening the various electrolytic cells 10 together by joint tightening. For example, the fastening means comprise a plurality of tie-rods 7. Each tie-rod 7 extends in a straight line in the electrolyzer stack 1. Each tie-rod 7 thus extends longitudinally in the electrolyzer stack 1 parallel to the general direction A. Each tie-rod 7 is in the shape of a shaft.

The tie-rods 7 therefore all extend parallel to each other. The tie-rods 7 are positioned on the perimeter of the various electrolytic cells. Preferably, the tie-rods 7 are distributed all around the block 2, preferably at regular intervals.

The tie-rods 7 extend through the base plates 3 and 4 of the electrolyzer stack 1, through specific holes in said base plates 3 and 4, and thus each have two ends outside the block 2.

Preferably, the tie-rods 7 are partially covered with a sleeve made from electrically insulating material. This makes it possible to avoid short circuits between the electrolytic cells in the event of contact or splashing. For example, the sleeve extends over the entire section of the tie-rod 7 arranged between the two base plates 3 and 4.

Preferably, the ends of the tie-rods 7 are threaded.

For example, the threads at the ends are rolled threads. Rolled threads have the advantage of making it easier to machine the tie-rods 7, in particular if the tie-rods 7 are very long, for example several meters long.

The fastening means also comprise nuts 8 screwed onto the ends of the tie-rods 7.

The nuts 8 make it possible to force the two base plates 3 and 4 together, and therefore force the various electrolytic cells together, which ensures satisfactory sealing of the stack of electrolytic cells.

Preferably, the fastening means also comprise means for prestressing the two base plates 3 and 4 together and therefore prestressing the various electrolytic cells together. Said prestressing means also make it possible to absorb the deformations and/or the variations in thickness of the constituent elements of the electrolyzer stack 1, due to thermal expansion or variations in the mechanical stresses outside and inside the electrolyzer stack 1 (such as for example the pressure inside the electrolyzer stack).

The prestressing means are received on the ends of the tie-rods 7 so that they are arranged, for a given end, between the nearest base plate (3 or 4) and the nuts 8 arranged on the same end.

For example, the fastening means comprise spring washers 9 such as Belleville washers. The spring washers 9 are received on the ends of the tie-rods 7.

Here, the spring washers 9 are more specifically positioned on each tie-rod 7, on the outer part of said tie-rod 7, when it has passed through the nearest base plate (3 or 4). The fastening means described above allow the electrolyzer stack 1 to withstand in particular the thermal expansions and/or variations in the mechanical stresses outside and inside the electrolyzer stack 1 (such as for example the pressure inside the electrolyzer stack).

In the present case, all of the electrolytic cells of the electrolyzer stack 1 are identical to each other, so the following description of one electrolytic cell 10 also applies to the description of the other electrolytic cells 10.

Such an electrolytic cell 10 comprises a central membrane 11 that is flanked by two electrodes 12a and 12b (an anode and a cathode respectively), which are in turn flanked by two inserts 16 (or flow field material), which are in turn flanked by two bipolar plates 14. In addition, the electrolytic cell 10 also comprises a seal 13 (the existence of which has already been mentioned above) that is compressed between the two bipolar plates 14 of the electrolytic cell 10.

The membrane 11, the inserts 16 and the electrodes 12a and 12b are known from the prior art and will not be described in detail herein.

The two bipolar plates 14 of an electrolytic cell 10 are identical to each other, and the following description of one of the bipolar plates 14 also applies to the other bipolar plate 14 of the same electrolytic cell 10. The bipolar plate 14 is made from a material capable of enduring the corrosive environment prevailing inside the electrolytic cell 10.

The bipolar plate 14 is for example nickel-based and is for example made from nickel or nickel carbon steel.

The bipolar plate 14 is further configured so that it has two main faces: a first main face facing toward the inside of the electrolytic cell 10 in question, and a second main face facing toward the outside of the electrolytic cell 10 in question.

It will be seen below that the bipolar plates 14 are asymmetrical (along a plane of symmetry passing through the center of the bipolar plate in question). As a result, within the same electrolytic cell 10, the first face of the bipolar plate 14 that is being described is facing a second face of another bipolar plate 14 identical to the one being described. Within the block 2, all of the bipolar plates 14 are oriented in the same manner.

Hereinafter, the axes X and Y are defined, which form a plane in which extends one of the main faces of the bipolar plate 14, together with the axis Z, which is normal to said plane XY.

When the bipolar plate 14 is in place in the electrolytic cell 10, which in turn is in place in the electrolyzer stack 1, the axis Z is coincident here with the general direction A.

The thickness of the bipolar plate 14 (along the axis Z) is smaller than its other dimensions.

The bipolar plate 14 is configured so that it has a transverse cross section (in a plane XY) of any geometric shape (square, rectangular, disk-shaped, etc.). Here, the bipolar plate has a disk-shaped transverse cross section.

The outer perimeter of the bipolar plate 14 is defined by a first zone 21, a second zone 22, and a third zone 23.

Here, the first zone 21 extends over the entire circumference of at least one of the main faces of the bipolar plate 14. The first zone 21 is therefore a ring forming the outer periphery of the main face.

The first zone 21 makes it possible to improve the resistance of the bipolar plate 14 to the pressure prevailing inside the electrolyzer stack 1 and makes it possible to improve the sealing of the electrolytic cell 10 with respect to the outside of the electrolyzer stack 1. Said first zone 21 particularly makes it possible to increase the resistance of the bipolar plate 14 in particular to the radial pressure loads exerted on the bipolar plate 14 (when the electrolytic cell 10 is arranged in the electrolyzer stack 1). For example, the first zone 21 is designed to comply with the standard applicable to pressure vessels, and for example with standard PED 2014/68/EU.

The first zone 21 is preferably textured. For example, the first zone 21 comprises grooves, striations, irregularities, a rough appearance, etc. on at least one of the main faces of the bipolar plate 14 and preferably on both main faces of the bipolar plate 14.

Conversely, the circular rim of the bipolar plate 14 (that is, the surface connecting the two main faces of the bipolar plate 14 together) is smooth, i.e. not textured.

In addition, the second zone 22 extends circumferentially so that it is bordered on the outside by the first zone 21. The second zone 22 is coaxial with the first zone 21.

Here, the second zone 22 extends over the entire circumference of at least one of the main faces of the bipolar plate 14. The second zone 22 is therefore a ring.

The second zone 22 is smooth, i.e. not textured.

This second zone 22 is located around the ducts for supplying electrolyte and the ducts for discharging the gaseous products of electrolysis.

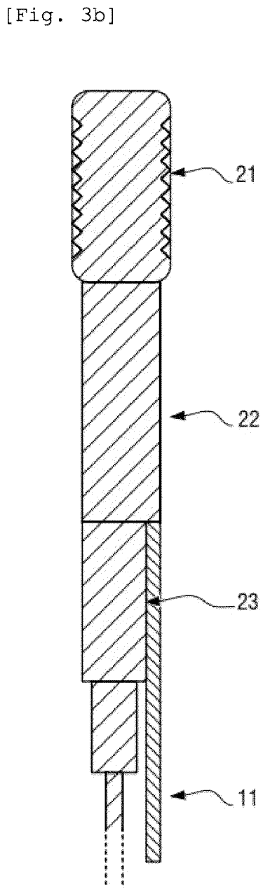

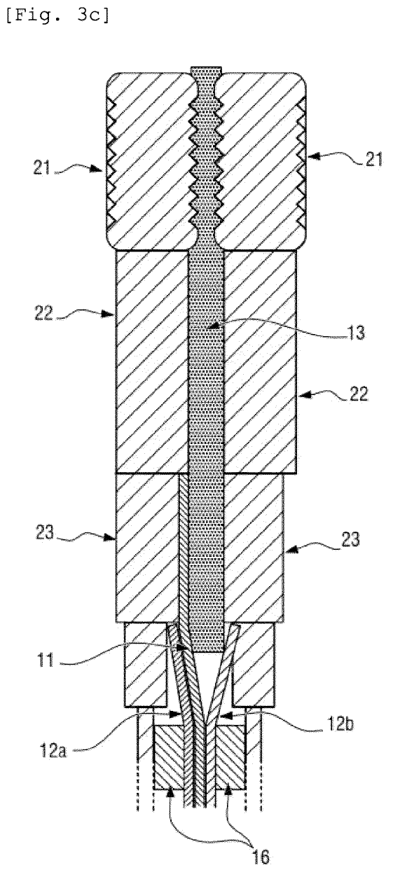

This second zone 22 is less thick (thickness being considered along the axis Z) than the first zone 21. For example, the bipolar plate 14 is configured to have at least one shoulder between the first zone 21 and the second zone 22. Preferably, the bipolar plate 14 is configured to have two shoulders between the first zone 21 and the second zone 22. Here, these two shoulders are identical (as can be seen in FIG. 3a) and made on both main faces of the bipolar plate 14.

The bipolar plate 14 is thus symmetrical along a central plane of symmetry parallel to the axes X and Y in the first zone 21 and the second zone 22 thereof.

The narrowing between the first zone 21 and the second zone 22 makes it possible to achieve different sealing between the two zones.

In addition, the third zone 23 extends circumferentially so that it is bordered on the outside by the second zone 22. The third zone 23 is coaxial with the second zone 22.

Here, the third zone 23 extends over the entire circumference of the bipolar plate. The third zone 23 is a ring.

This third zone 23 is less thick (thickness being considered along the axis Z) than the second zone 22. For example, the bipolar plate 14 is configured to have at least one shoulder between the second zone 22 and the third zone 23.

Preferably, the bipolar plate 14 is configured to have a single shoulder between the second zone 22 and the third zone 23. This shoulder is made on the first main face of the bipolar plate 14, that is, the one facing toward the inside of the electrolytic cell 10. This shoulder makes it possible to accommodate the membrane 11.

Preferably, the second zone 22 and the third zone 23 extend continuously on the second main face of the bipolar plate 14.

There is therefore no shoulder between the second zone 22 and the third zone 23 on the second main face.

It will therefore be understood that the second face of the bipolar plate 14 does not have such a shoulder, so the second face of the other bipolar plate of the electrolytic cell in question does not have such a shoulder. The membrane 11 is thus arranged between the two bipolar plates so that it is accommodated solely in the shoulder of one of the two bipolar plates 14.

The bipolar plate 14 is thus asymmetrical along a central plane of symmetry parallel to the axes X and Y when considering the aforementioned three zones (as can be seen most clearly in FIGS. 3a, 3b, and 3c).

The third zone 23 is entirely smooth (i.e. not textured), or partially smooth, or entirely textured. Preferably, the third zone 23 is textured on the first main face of the bipolar plate 14. This makes it easier to hold the membrane 11 in place. For example, on said first main face, the third zone 23 comprises grooves, striations, irregularities, a rough appearance, etc.

Preferably, the third zone 23 is smooth on the second main face of the bipolar plate 14.

The thickness of the bipolar plate 14 (along the axis Z) therefore decreases gradually with the shoulders, at the junction between the first and second zones 21 and 22, and also at the junction between the second zone 22 and the third zone 23. The bipolar plate 14 is thus thicker in the first zone 21 thereof than in the second zone 22 thereof and in the second zone 22 thereof than in the third zone 23 thereof.

The first zone 21, the second zone 22, and the third zone 23 jointly form a crown 25. The crown 25 thus forms the circumferential periphery of the bipolar plate 14.

In addition, a central portion 24 of the bipolar plate 14 extends so that it is bordered on the outside by the third zone 23. The central portion 24 is coaxial with the third zone 23.

The central portion 24 is solid. The central portion 24 thus forms a circular platform.

This central portion 24 is less thick (thickness being considered along the axis Z) than the third zone 23.

For example, the bipolar plate 14 is configured to have at least one shoulder between the third zone 23 and the central portion 24. Preferably, the bipolar plate 14 is configured to have two shoulders between the third zone 23 and the central portion 24. Here, these two shoulders are identical and made on both main faces of the bipolar plate 14.

The central portion 24 can optionally have in turn at least one shoulder so that the thickness thereof (thickness being considered along the axis Z) narrows toward the center of the plate.

The central portion 24 is therefore the thinnest part (thickness being considered along the axis Z) of the bipolar plate 14.

The central portion 24 can be smooth or textured.

The central portion 24 acts as a current collector and transmits this current to the inserts 16, which are on either side of it.

In addition, the bipolar plate 14 comprises orifices 15 passing through it from one side to the other. These orifices 15 are dedicated to supplying electrolyte solution and discharging the products of electrolysis.

For example, the bipolar plate 14 comprises between three and six orifices. The orifices are for example associated two by two, the pairs of two orifices being evenly distributed over the circumference of the bipolar plate 14. The bipolar plate can thus comprise three pairs of two orifices.

For example, at least one of the orifices 15 is made in the second zone 22. In the present case, all of the orifices 15 are made in the second zone 22.

The orifices can have a transverse cross section that is circular, oblong, or another shape. For example, at least one of the orifices 15 has an oblong transverse cross section.

In a manner known per se, one or more additional orifices extend from the orifice 15 toward the central portion 24 in order to make it possible to supply electrolyte solution and discharge the products of electrolysis to and from the inside of the electrolytic cell. These additional orifices extend radially for example. In order to prevent the seal 13 from obstructing the orifices, they are preferably made at least partially on the surface of the bipolar plate 14 and laterally closed by one or more covers that are in turn in contact with the seal.

In reality, the role of said central portion 24 is not really to withstand high pressure against the crown 25. The main role of the central portion 24 is thus to act as a support for the components stacked within the electrolytic cell 10, namely the inserts 16, the electrodes 12a and 12b, and the membrane 11. The forces are therefore equal on the two faces of the central portion 24.

As a result, the bipolar plates 14 have a particular geometry. The thickness of each aforementioned zone varies from another by a few tenths of a millimeter to several millimeters. The thickness of an aforementioned zone also has a variable value under the effect f the thermal expansion of the bipolar plate 14 (the variability of the thickness of each zone due to thermal expansion thus also varying from one zone to another).

As already stated, within the electrolytic cell 10, the two bipolar plates 14 compress a seal 13 between them.

It should be noted that within the electrolyzer stack 1, all of the bipolar plates 14 are separated two by two by a seal 13 (as each bipolar plate 14 acts as the cathode for one electrolytic cell 10 and the anode for another immediately adjacent electrolytic cell 10).

Advantageously, the two bipolar plates 14 compress a single seal 13 between them.

Advantageously, all of the seals 13 of the electrolytic cells 10 are identical within the block 2 of cells, so the following description of one of the seals 13 also applies to the other seals 13 of the other electrolytic cells 10. The main functions of the seal 13 are as follows: i) to seal each electrolytic cell 10 with respect to the outside of the electrolyzer stack 1, ii) to seal the ducts conveying one gas that is generated within the block 2 with respect to those conveying another gas generated within the block 2, iii) to seal the chambers in which the electrolytic reactions take place that generate the two aforementioned gases in order to isolate them from each other and also to seal them with respect to the ducts mentioned just before that, iv) to act as an electrical insulation layer between two adjacent bipolar plates 14, and v) to define the thickness to which the electrolytic cells 10 are compressed in the direction Z.

Advantageously, a single seal 13 is compressed between two adjacent bipolar plates 14 within one and the same electrolytic cell 10.

Preferably, the seal 13 is shaped so that it has a square or rectangular transverse cross section (along a transverse section plane).

The seal 13 is therefore referred to as a “flat seal”.

Preferably, the seal 13 is shaped so that it corresponds to the shape of the crown 25 of the associated bipolar plate 14.

In the present case, the seal 13 is generally in the shape of a ring, the associated bipolar plate 14 being disk-shaped.

It will be noted that the seal 13 is pierced with a plurality of holes.

This makes it possible to supply the block 2 and discharge the fluids from the block 2. For example, the holes made in the seal 13 correspond to those made in the zone 22 of the bipolar plate 14.

The seal 13 is configured so that it has a diameter (of its transverse cross section) that is as constant as possible on all of its inner and outer circumferences and/or a thickness (along the axis Z) that is as constant as possible over its entire extent (and also from one seal 13 to another).

This makes it possible to improve the efficiency of the electrolytic cells 10 of the electrolyzer stack 1.

It particularly makes it possible to have faces of the seal 13 that are as parallel as possible to each other and to the main faces of the facing bipolar plates 14.

This further improves the sealing of the assembly.

The tolerance regarding the dimensions of the seal 13 depends on the application for which it is intended (for example, the thickness tolerance is ±0.1 millimeters).

As already stated, and as can be seen more clearly in FIG. 3c, the seal 13 is compressed between two adjacent bipolar plates 14, and more specifically between the two outer perimeters of the facing main faces of said bipolar plates 14, and more specifically between the two facing crowns 25 of said bipolar plates 14.

Due to the particular geometry of the bipolar plates 14 on the outer perimeter thereof, and in particular the crown 25 thereof, when they compress the seal 13, the bipolar plates 14 deform it in turn so that they define and characterize said seal 13 into three separate portions.

However, the seal 13 is not compressed between the central portions 24 of said two bipolar plates 14.

The diameter of the seal 13 (along a transverse cross section) is such that the seal 13 extends from the lateral edge of the bipolar plates 14 to the junction between the third zones 23 and the central portions 24 (preferably extending beyond the third zones 23).

Each portion of the present seal 13 thus performs a separate sealing function and is characterized by a specific compression level, which varies from one portion to another. The physical and mechanical consequence is the variable reduction in thickness of said seal 13 depending on the portion under consideration.

When the seal 13 is in the rest state, it thus has a conventional annular shape and a substantially single initial thickness.

When the seal 13 is compressed between two plates 14:
between the first zones 21 of the two bipolar plates 14, the seal 13 has a corresponding textured first portion because it follows the geometry of said first zones 21,
between the second zones 22 of the two bipolar plates 14, the seal 13 has a corresponding smooth second portion, the seal 13 then also having a greater thickness than in the first portion thereof,
between the third zones 23 of the two bipolar plates 14 and the membrane 11, the seal 13 has a corresponding smooth and/or grooved third portion.

In the first portion thereof, the seal 13 is directly compressed between the two first zones 21 (without an intermediate component).

In the second portion thereof, the seal 13 is directly compressed between the two second zones 22 (without an intermediate component).

However, in the third portion thereof, the seal 13 is not directly compressed between the two third zones 23. In fact, the membrane 11 is also present between these two third zones 23. As a result, the seal 13 is compressed directly on one face thereof by one of the third zones 23 and directly on the other face thereof by the membrane 11, which in turn is compressed directly by the third zone 23 of the facing bipolar plate 14.

In the third portion thereof, the seal 13 then has a substantially smaller thickness than in the second portion thereof, the membrane 11 filling the rest of the space between the two third zones 23. The membrane 11 is thus sealed.

The seal 13 is thus distributed over its entire height (along the axis X) between the three portions thereof and therefore between the three zones of the crowns 25.

As a result, the part of the electrolytic cell 10 situated in the first zones 21 of the two bipolar plates 14 and the first portion of the seal 13 makes it possible to prevent the electrolyte solution or gases from leaving the electrolyzer stack 1, that is, it is dedicated to sealing the electrolytic cell 10 with respect to the external environment. It ensures for example a leakage rate less than or equal to 10⁻³ milligrams per meter per second—mg/(m*s) when the leakage rate is measured using a helium gas—and preferably a leakage rate less than or equal to 10⁻⁴ mg/(m*s).

This first part is characterized by the presence of textures on the bipolar plates 14, in which the seal 13 deforms. In particular, by deforming, the seal 13 can fill the hollows of the first parts of the bipolar plates 14 and thus increase the sealing of the electrolytic cell 10. This is because these textures form an additional obstacle to the gases and other substances present finding the path out of the electrolyzer stack 1. This presence of textures also acts to promote the friction between the electrolytic cells 10 and therefore the self-holding ability of the plurality of electrolytic cells 10 stacked to form the block 2. This advantage is increased when the block is horizontal during operation.

For example, the compression of the seal 13 is such that the seal 13 reaches, in the first part, a maximum thickness (along the axis Z) of 94%, and preferably 78%, and preferably 75%, of its initial thickness (when it is in the rest state lying flat on a flat surface without external stresses). The initial thickness is for example equal to or greater than 3.0 millimeters. Preferably, this initial thickness is no greater than 3.5 millimeters.

The second part of the electrolytic cell 10 situated in the second zones 22 of the two bipolar plates 14 and the second portion of the seal 13 makes it possible to prevent any exchange between the ducts conveying the hydrogen and oxygen in the electrolytic cell 10 or from the electrolytic cell 10 itself (starting from the third zone 23 and the central portion 24) to said ducts.

For example, the compression of the seal 13 is such that the seal 13 reaches, in the second part, a thickness (along the axis Z) of between 92 and 97% of its initial thickness (when it is in the rest state lying flat on a flat surface without external stresses), and preferably a thickness of 92% of its initial thickness. In any event, the seal 13 is less compressed than in the first part and therefore has a greater thickness than in the first part.

The widening of the seal 13 between the first zones 21 and the second zones 22 makes it possible to achieve different sealing between the first zones 21 and the second zones 22. In particular, the sealing between the first zones 21 and the second zones 22 is of high quality.

The third part of the electrolytic cell 10 situated in the third zones 23 of the two bipolar plates 14 and the third portion of the seal 13 makes it possible to receive the membrane 11, as already stated.

This third part therefore ensures the sealing between the anode and cathode compartments of the electrolytic cell 10. It will therefore be noted that both the membrane 11 and the seal 13 are then compressed between the two bipolar plates 14 in this third part; the seal 13 is thus superposed on the membrane 11 in this part of the electrolytic cell 10.

This ensures a very good seal around the membrane 11 on its perimeter and toward the fluid supply and discharge ducts. The third portion of the seal 13 thus defines a third compression zone that aims to hold the membrane 11 and seal the perimeter thereof.

For example, the compression of the seal 13 is such that the seal 13 reaches, in the third part, a thickness (along the axis Z) of between 86 and 92% of its initial thickness (when it is in the rest state lying flat on a flat surface without external stresses) and preferably a thickness of between 88 and 92% of its initial thickness, and preferably a thickness of 90% of its initial thickness.

According to another aspect, the seal 13 is made from a monomer material or a polymer material, and for example from a plastic material.

For example, the seal 13 is made from a material of the polytetrafluoroethylene or polytetrafluoroethene type (commonly abbreviated to PTFE or better known by its trade name Teflon—registered trademark).

Preferably, the material is made from or based on or of the polytetrafluoroethylene or polytetrafluoroethene type to which at least one filler is added. The filler is for example glass fiber.

Said material is for example reinforced polytetrafluoroethylene. The reinforced polytetrafluoroethylene is for example glass-fiber reinforced polytetrafluoroethylene or the reinforced polytetrafluoroethene is carbon-fiber reinforced polytetrafluoroethene.

The properties of the seal 13 described are defined below:
long-term satisfactory behavior of the material and retention of the satisfactory mechanical properties thereof at the operating temperature of the electrolytic cell 10, which is significant (typically of the order of 90 to 95 degrees Celsius);
long-term resistance to the corrosive environment inside the electrolytic cell 10;
satisfactory sealing properties;
satisfactory electrical insulation properties (provided by satisfactory electrical resistance), even at the operating temperature and in contact with the electrolyte solution;
low creep, allowing satisfactory longevity of the stack of electrolytic cells 10;
slight creep behavior however, in order to follow as closely as possible the geometric features of the zone 21 on which the seal 13 is seated;
uniform thickness (along the axis Z).

According to one option, the end seal arranged between the first distribution plate 5 and the first base plate 3 is made from the same material as the seal 13 of an electrolytic cell 10 as described above. The end seal is for example identical to said seal 13. Said end seal is optionally made from a monomer material or a polymer material, and for example from a plastic material.

According to one option, the layer made from electrically insulating material between the first base plate 3 and the first distribution plate 5 is made from the same material as the end seal arranged between the first distribution plate 5 and the first base plate 3. According to one option, the layer made from electrically insulating material between the first base plate 3 and the first distribution plate 5 is made from the same material as said seal 13. Said layer is optionally made from a monomer material or a polymer material, and for example from a plastic material.

According to one option, the end seal arranged between the second distribution plate 6 and the second base plate 4 is made from the same material as the seal 13 of an electrolytic cell 10 as described above. Said end seal is for example identical to said seal 13. Said end seal is optionally made from a monomer material or a polymer material, and for example from a plastic material.

According to one option, the patch arranged on the inner face of the first distribution plate 5 is a layer of material directly attached to the first distribution plate 5 or is formed by powder coating (by Halar (registered trademark) coating, for example).

The electrolytic cell 10 thus described has very good sealing due to the specific compression of the seal 13 between the bipolar plates 14.

In addition, it will be noted that the electrolytic cell 10 is sealed by means of a single seal 13, with three different sealing and compression zones.

The use of a single seal 13 made from plastic (and not an elastomer as in the prior art) also makes it possible to improve the sealing of the electrolyzer stack.

This is because the seal 13 withstands the corrosive environment prevailing inside the electrolyzer stack 1 better, even over a long period.

The seal 13 is thus made from a hard material that can withstand the significant mechanical compression to which the electrolyzer stack is subjected.

A method for assembling the electrolyzer stack 1 will now be described.

According to a first step, sub-assemblies are individually constructed, each sub-assembly being formed by assembling two inserts 16 and two electrodes 12a, 12b on either side of a bipolar plate 14. Strictly speaking, each sub-assembly forms two electrolytic half-cells placed side by side.

In a second step, said sub-assemblies are stacked in succession, separated from each other by a membrane 11 and a seal 13, forming said electrolytic cells 10 electrically connected in series. The last electrolytic cell 10 of one end of the block 2 is covered by the second distribution plate 6, in turn covered by the second base plate 4, and the last electrolytic cell 10 of the other end of the block 2 is covered by the first distribution plate 5, in turn covered by the first base plate 3, thus defining the electrolyzer stack 1.

During a third step, the newly-assembled electrolyzer stack 1 is compressed by means of tie-rods 7, nuts 8, and spring washers 9.

To this end, pre-tightening of the electrolyzer stack 1 (and therefore of the various layers of the electrolytic cell 10 together, and the seals 13) is carried out.

This third step is preferably carried out at ambient temperature. For example, this third step is carried out at a temperature of between 15 and 25 degrees Celsius, and for example between 18 and 22 degrees Celsius.

Pre-tightening is obtained for example by action on the nuts 8 of the tie-rods 7. Preferably, a plurality of nuts 8 are tightened simultaneously. Preferably, the nuts 8 are all split into groups, each group being tightened one after the other, and the nuts in one and the same group being tightened simultaneously. Preferably, the groups are tightened in a staggered or star sequence. One group of nuts 8 can for example be tightened at the same time, before moving on to the next group, the nuts of which are situated as close as possible to the nuts 8 of the first group, and so on. Preferably, during this phase, all of the nuts 8 are tightened.

During the third step, a plurality of nuts 8 are thus acted on at once, but all of the nuts 8 of the block are not tightened at the same time.

This makes it possible to ensure that the thickness of the seals 13 is reduced relatively evenly and uniformly over the entire circumference of the various seals.

Pre-tightening can be carried out for example using hydraulic means, for example hydraulic cylinders.

During this third step, the electrolyzer stack is preferably tightened so that it reaches a threshold characteristic of a desired initial compression ratio of at least one of the seals 13 and preferably all of the seals 13.

This threshold can be defined, for example, on at least one of the following conditions:
at the end of the first phase, at least one of the seals (and preferably all of the seals 13) must ensure contact between the two bipolar plates 14 and the membrane 11 within a given cell, and/or
at the end of the first phase, at least one of the seals (and preferably all of the seals 13) must have a compression ratio of between 25 and 50% of a desired final compression ratio of at least one of the seals 13 and preferably all of the seals 13.

The threshold can thus be a target thickness of at least one of the seals, or a target thickness of a plurality of seals, or a target thickness of the electrolyzer stack 1, or a target tightening torque of the electrolyzer stack. In order to estimate whether the tightening is close to the threshold, during the first phase for example, a thickness of at least one of the seals, or a thickness of the electrolyzer stack, or the tightening torque applied to the electrolyzer stack, is correspondingly measured.

In particular, this third step comprises a series of tightening sessions so that the electrolyzer stack is tightened in stages. Preferably, at the end of each stage, the distance from the threshold is estimated in order to control the tightening torque on the next stage.

During a fourth step, the electrolyzer stack 1, and therefore the block 2, are then subject to successive tightening cycles.

A tightening cycle comprises the following phases.

First phase: Heating the electrolyzer stack 1.

This first phase takes place for example by injecting a gas or a liquid (such as steam, for example water vapor, or a hot liquid, for example hot water) through some of the inlet and outlet orifices of the base plate 4 in order to heat the whole of the interior of the electrolyzer stack 1, and particularly the seals 13. Alternatively, the gas or liquid can be at ambient temperature inside the electrolyzer stack. For example, heating means can be temporarily introduced into the electrolyzer stack 1 in order to heat the gas or the liquid (for example, the heating means can comprise one or more resistors). Optionally, the heating means are temporarily introduced into the electrolyzer stack 1 through the orifices 15 of the bipolar plates 14.

Second phase: Tightening the electrolyzer stack 1 (and therefore the various layers of the electrolytic cell 10 together, and the seals 13).

Tightening is obtained for example by action on the nuts 8 of the tie-rods 7. Preferably, a plurality of nuts 8 are tightened simultaneously. Preferably, the nuts 8 are all split into groups, each group being tightened one after the other, and the nuts in one and the same group being tightened simultaneously. Preferably, the groups are tightened in a staggered or star sequence. One group of nuts 8 can for example be tightened at the same time, before moving on to the next group, the nuts of which are situated as close as possible to the nuts 8 of the first group, and so on. Preferably, during this phase, all of the nuts 8 are tightened.

During the second phase, a plurality of nuts 8 are thus acted on at once, but all of the nuts 8 of the block are not tightened at the same time.

This makes it possible to ensure that the thickness of the seals 13 is reduced relatively evenly and uniformly over the entire circumference of the various seals.

Tightening can be carried out for example using hydraulic means, for example hydraulic cylinders.

It will be understood that tightening is carried out hot due to the preceding phase, and not at ambient temperature as in the third step.

Third phase: Cooling the electrolyzer stack 1.

This cooling can be natural (by stopping the heating of the electrolyzer stack 1, as it is in contact with air at ambient temperature, which allows the natural cooling thereof) and/or forced [for example by injecting a gas or a liquid (such as cold water) through some of the inlet and outlet orifices of the base plate 4 in order to cool the whole of the interior of the electrolyzer stack 1, and particularly the seals 13/by ventilation/etc.].

Fourth phase: Tightening the electrolyzer stack 1 and therefore the various layers of the electrolytic cells 10, and the seals 13.

This tightening is carried out as in the second phase, but at ambient temperature as in the third pre-tightening step (the temperature ranges given can also be applied here).

During the fourth step, a series of tightening operations is thus carried out with the electrolyzer stack 1, and therefore the block 2, hot and then at ambient temperature. Given that the hot tightening is carried out at a higher temperature than the ambient temperature tightening, it can also be said that a series of tightening operations are carried out with the electrolyzer stack 1, and therefore the block 2, hot and then cold.

The second phase (particularly on its first iteration if phases 1 to 4 are repeated several times) allows a significant reduction in the individual thickness of the various seals 13.

Phases 1 to 4 are repeated again, preferably until a threshold is reached that is characteristic of a desired final compression ratio of at least one of the seals 13 and preferably all of the seals 13.

The threshold can be defined, for example, by taking into account:
the desired sealing performance on at least one of the seals 13, and preferably all of the seals, and preferably of the electrolyzer stack 1 as a whole, and/or
the desired geometric compression of the electrolyzer stack 1 so that the electrical contacts are satisfactory for achieving a given output and/or a given electrical continuity, and/or
the desired mechanical stability of the material forming the seal or seals 13 so that the creep phenomenon does not excessively impair the sealing of the electrolyzer stack 1.

Preferably, the aforementioned threshold is linked to at least one compression ratio of at least one of the seals 13, and preferably all of the seals 13.

Preferably, the aforementioned threshold is linked to at least the compression ratio of the portion of at least one of the seals 13 (and preferably all of the seals 13) linked to the first zones 21 of the facing bipolar plates 14.

Yet more specifically, the aforementioned threshold is linked to the compression ratios, defined above, linked to the different portions of at least one of the seals, and preferably all of the seals 13.

It should be noted that as of the first iteration, the seals 13 have a thickness close to their target value. The subsequent iterations are thus aimed more at eliminating the plastic behavior of the seals in their operating range. Preferably, after each tightening phase (second phase and fourth phase), at least one parameter is measured among the following parameters: a thickness of at least one of the seals, a thickness of the electrolyzer stack or the block, a distance between the base plates 3 and 4, and a tightening torque applied to the electrolyzer stack. For example, after each tightening phase, the thickness of all of the seals 13 is estimated by measuring the distance between the base plates 3 and 4 or the tightening torque applied to the electrolyzer stack 1.

Procedure 1 This makes it possible to control the repetition of phases 1 to 4 by estimating the progress toward the final threshold. For example, the final threshold is a target thickness value of the electrolyzer stack 1. For example, after each tightening phase, the thickness of the electrolyzer stack 1 is checked. Optionally, the thickness of the block 2 is measured by measuring the thickness between the base plates 3 and 4 at different points on the circumference of the block 2; the mean of the different values obtained is then found in order to obtain a mean thickness of the block 2; on the basis of the number of cells and the thickness of the different elements per cell, the mean thickness of each of the seals 13 is deduced. A ratio Hn+1/Hn is deduced therefrom, where Hn is the change in thickness to be achieved in order to reach the target thickness (here the final threshold) following the tightening phase that has just been carried out and Hn+1 is the change in thickness to be achieved in order to reach this target thickness during the next tightening phase. This ratio makes it possible to monitor the progress of the fourth step.

Preferably, the fourth step is implemented so that this ratio is maintained in a given range throughout the fourth step. Preferably, when the second phase is implemented for the first time, a ratio Hn+1/Hn of less than 0.5 (meaning that the change in thickness has been reduced by more than 50%) and preferably less than 0.4 (meaning that the change in thickness has been reduced by more than 60%) is aimed for. For example, a ratio Hn+1/Hn of between 0.5 and 0.25, and preferably of between 0.4 and 0.25, is aimed for.

### PROCEDURE 2

This makes it possible to estimate the zones of the electrolyzer stack 1 that have thicknesses that are abnormally greater than the other zones of said stack. Then, during the next tightening phase, it is possible to adapt the tightening by targeting the nuts by means of which preferential tightening must be carried out in order to rectify a zone that is abnormally thicker than the other zones of the electrolyzer stack 1. A lack of parallelism between the bipolar plates 14 and/or the cells can thus be corrected during the various tightening phases. This is essential in order to ultimately ensure satisfactory electrical contact between the various electrolytic cells 5 on the entire surface of said cells. This also makes it possible to retain an electrolyzer stack 1 that is as straight and as centered as possible on its axis Z. This also makes it possible to have base plates 3 and 4 that are correctly aligned and parallel to each other. For example, the inventors have observed that any lack of parallelism between the base plates 3 and 4 was less than one millimeter for an electrolyzer stack 5 meters long (length taken along the axis Z).

Preferably, the first procedure and/or the second procedure are also implemented for the third pre-tightening step. Preferably, the seal 13 is heated using steam (by steaming). This makes it possible to carry a large amount of energy in a small amount of fluid that corresponds to the size of the ducts. Yet more specifically, the thickness of the seal 13 is reduced permanently in order to reach the predefined compression ratios. In addition, the plastic behavior (or creep) of said seal 13 is attenuated over the course of the hot and ambient temperature tightening cycles until an elastic behavior range is reached. As a result, at the end of this fourth step, the seal 13 exhibits linear deformation behavior. This behavior makes it possible (due to the counter-balancing force induced by the spring washers 9) to ensure sealing for the various zones of the bipolar plates 14 in particular in view of the expansions and pressures applied to the electrolyzer stack 1.

The plastic nature of the seal 13 is thus eliminated.

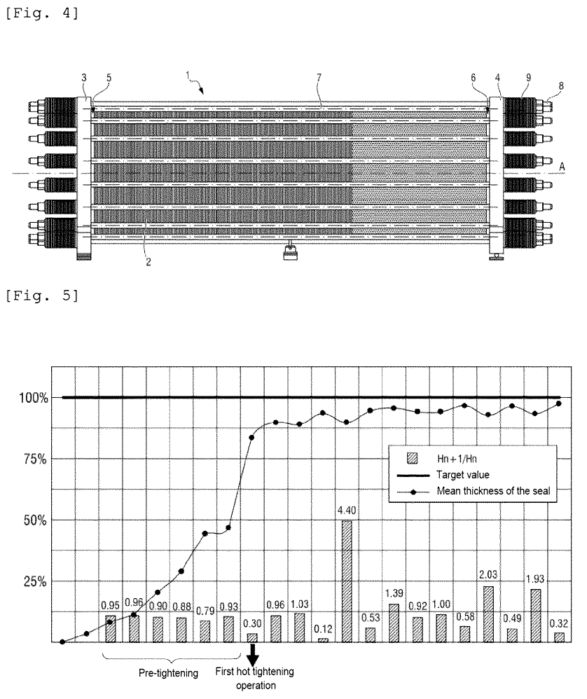

The thickness of the seal 13 (along the axis Z) is thus reduced gradually but drastically by plastic deformation of said seal 13. FIG. 5 shows this reduction in the thickness of the seal 13 during the various steps and phases of the assembly method described. The curve thus illustrates the change in the mean thickness of the seal 13 (determined as stated above or by another method) during the different steps and phases of the assembly method described, the 100% value corresponding to the target thickness reduction.

For example, at least on some portions of the seal 13, the thickness of the seal 13 is reduced by at least 10%, or at least 15%, or at least 20%, or at least 25%.

This makes it possible to limit the creep of the seals 13 during the actual operation of the electrolyzer stack 1.

As a result, the seals 13 ensure very good sealing of the electrolyzer stack 1, even over time on the scale of 10 or 20 years.

Some of the tightening is cleverly carried out hot, which makes it possible to take advantage of the softer (less hard) nature of the material of the seal 13 at high temperatures.

Such an assembly with thick distribution plates 5 and 6 and thin, flat bipolar plates 14 allows a homogeneity of the current in all of the electrolytic cells 10 of the electrolyzer stack 1 when the voltage is different at the terminals of each electrolytic cell 10 and the current is only connected to one or more points on the periphery of each distribution plate 5 and 6.

In addition, the bipolar plates 14 are parallel to each other within the block 2 due to their particular shape and the satisfactory tightening of each seal 13. This further improves the homogeneity of the current in all of the electrolytic cells 10.

The assembly method described above particularly makes it possible for each seal 13:
to deform according to the geometry imposed by the bipolar plates clamping it,
to sink into the textures of the first zones 21 in order to fill them,
to purposely cause the material from which it is made to age prematurely,
to eliminate as far as possible the plastic behavior of the material from which it is made,
to introduce a range of elastic behavior into the material thereof (centered on an operating point of the electrolyzer stack),
to reach the desired tightening value that achieves both the desired sealing and the electrical contacts between the various components, making it possible to achieve the envisaged energy performance.

At the end of the fourth step, the temperature and pressure prevailing inside the electrolyzer stack 1 can change, but the seals will advantageously always remain in the elastic range obtained. The nominal operating point of the electrolyzer stack is for example 85 degrees Celsius at 3 megapascals.

Of course, the invention is not limited to the embodiment described but encompasses any variant that falls within the scope of the invention as defined by the claims.

The assembly method described applies advantageously to all types of electrolyzer stack 1, regardless of their thermal and mechanical properties, number, or size or the nature of the material forming said electrolyzer stack 1.

The end seal or seals can be different from the seals 13.

The electrolyzer stack 1 can be assembled using a different method from the one described.

Although the electrolyzer stack is cooled here (natural and/or forced cooling) to ambient temperature, the electrolyzer stack can be cooled to a value greater than ambient temperature. For example, the electrolyzer stack can be cooled so that the temperature thereof is less than 35 degrees Celsius and for example between 15 and 35 degrees Celsius, and for example between 20 and 35 degrees Celsius. The cold tightening can thus take place at a different temperature between two successive cold tightening operations (provided therefore that the electrolyzer stack is at a lower temperature than the hot tightening temperature and close to ambient temperature, preferably without falling below 15 degrees Celsius, which could hinder the plasticity of the material of the seals) and/or at a different temperature from the first tightening phase.

Although the assembly method makes it possible to assemble an electrolytic stack, the assembly method can make it possible to assemble other stacks of elements, for example a heat exchanger, press, a filter press etc. and preferably stacks of elements which have to be used over long periods and/or require significant levels of sealing. The stack of elements can be used horizontally, vertically, or in any other position. The stack of elements can be assembled horizontally, vertically, or in any other position. Preferably, the stack of elements is assembled vertically and used horizontally.

1. A method for assembling a stack of elements, comprising the steps of:
individually assembling subassemblies of said elements,
assembling the subassemblies together, arranging a seal between each subassembly to form the stack of elements,
applying successive heating and cooling phases to the stack of elements, applying at least one operation of tightening the stack of elements between two different heating and cooling phases.

2. The method as claimed in claim 1, wherein the stack of elements is an electrolyzer stack, the subassemblies thus being pairs of electrolytic half-cells.

3. The method as claimed in claim 1, comprising a step of pre-tightening the stack of elements before the step of applying successive heating and cooling phases to the stack of elements, applying at least one operation of tightening the stack of elements between two different heating and cooling phases.

4. The method as claimed in claim 3, wherein the pre-tightening step is carried out incrementally.

5. The method as claimed in claim 1, wherein the elements are heated by injecting steam into the elements.

6. The method as claimed in claim 5, wherein the steam is water vapor.

7. The method as claimed in claim 1, wherein the elements are heated by injecting hot water into the elements.

8. The method as claimed in claim 1, wherein the cooling of the elements is forced.

9. The method as claimed in claim 1, wherein the cooling of the elements is natural.

10. The method as claimed in claim 1, wherein at least two iterations of the following phases are carried out:
heating the inside of the stack of elements,
tightening the various elements with respect to one another,
cooling the various elements with respect to one another,
tightening the various elements with respect to one another.

11. The method as claimed in claim 10, wherein the iterations are stopped when at least one predefined compression ratio of at least one seal in the stack of elements is reached.

12. The method as claimed in claim 10, wherein at least one subassembly is assembled by fastening two bipolar plates together to clamp at least one seal between the two plates.

13. The method as claimed in claim 12, wherein a single seal is clamped between the two bipolar plates.

14. The method as claimed in claim 10, wherein the stack of elements is arranged vertically and/or horizontally.
